(19) United States
(12) Patent Application Publication
(10) Pub. No.: US 2004/0039757 A1
(43) Pub. Date: Feb. 26, 2004

(54) System, method, and apparatus for managing form-based business records

(76) Inventor: William B. McClure, Lafayette, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/649,235

(22) Filed: Aug. 26, 2003

Related U.S. Application Data
(60) Provisional application No. 60/406,356, filed on Aug. 26, 2002.

(51) Int. Cl. G06F 12/00

(52) U.S. Cl. 707/201

(57) ABSTRACT

A method and apparatus for managing, storing and indexing form-based business records (“forms”). Forms may be selected, printed, scanned, and indexed locally though use of an integrated device (“box”). A copy of a form may be transmitted across a network to a remote storage location, where the form is stored and indexed. All transmission between the box and remote storage location is user-transparent; to a user, the remote storage location appears as a local output device. Forms may be downloaded from the remote storage location through the box for manipulation, and transmitted back to the remote storage location for storage as necessary.

### CROSS-REFERENCE TO RELATED APPLICATIONS

This application claims priority to U.S. provisional application No. 60/406,356, filed Aug. 26, 2002, entitled: “System, Method, and Apparatus for Managing Form-Based Business Records.” This application is hereby incorporated by reference as if fully disclosed herein.

### BACKGROUND OF THE INVENTION

1. Field of the Invention

The present invention is related to a system and method for managing business records, and more particularly to a system and method for creating, printing, scanning, storing and indexing form-based business records.

2. Discussion of Background Art

Presently, approximately 25 million businesses in the United States employ under 20 employees. These businesses are generally referred to as “small businesses.” Worldwide, the number of small businesses is far greater.

Small businesses have the same record keeping and file upkeep requirements as any other business. For example, many medical offices (such as doctors' and dentists' offices) are legally required to maintain patient files for a certain time period. Other businesses (for example, law firms) may be required to maintain and handle client records for a certain time by their insurance carriers. Yet other businesses maintain client records to enhance customer service. However, many small businesses continue to maintain paper records (rather than electronic) due to the cost and/or perceived complexity of electronic document management systems.

Accordingly, what is needed is an improved electronic document management and storage system.

### SUMMARY

Generally, one embodiment of the present invention takes the form of a form-based business record management system. The system may create, print, scan, store, transmit, index, and retrieve form-based records. Typically, the embodiment electronically stores and processes form-based records, or “forms.” The terms “form-based records” and “forms,” as used herein, are intended to embrace any sort of document amenable to computer-based indexing and management. For example, patient and client records are examples of forms, as are insurance claims and waivers. Word processing documents are yet another example of forms, as are spreadsheets and electronic mail messages.

One embodiment is capable of managing form-based records by generating a unique identifier, printing a form including the unique identifier, scanning the form to capture information including the unique identifier, and storing the information as a record in a database, as well as indexing the record by the unique identifier.

A user may select one of a variety of form-based records for review, printing, modification, scanning, and storage. The form may be locally stored, provided by a third party or third-party software application, or a preexisting physical form the user wishes to incorporate into the embodiment. Further, the form may be retrieved from a remote storage location across a network connection between the local device portion of the embodiment (or “box”) and the remote storage location. The remote storage location is generally presented to the user as a locally mapped input or output device, rather than a network component. The user may browse the available forms through a web browser.

Once the user selects the desired form, it may be reviewed. After reviewing the form, the user may print the form on an output device attached to the box. Alternatively, the user may print the form without review, thus skipping the display and review process. Prior to printing, the embodiment typically generates a unique document identifier and associates it with the form. The printed form may then be filled out, adjusted, revised, or otherwise completed by the user or another person.

Once the form has been completed, changed, or reviewed as necessary, the user may scan the form. The scan operation converts the form into an electronic file format (such as XML or PDF formats), which may then be stored on a computer-readable storage medium. The storage medium may be a local medium (i.e., co-located with or integrated into the box), or may be remotely accessed by the box across a network.

The embodiment may store the electronic file either locally or remotely. For example, the electronic file may be stored on a hard disk located at the user's place of business. Alternatively, the embodiment may employ the network connection to transmit the file to the remote storage location. Such transmission may occur immediately after a document is scanned and corresponding electronic file created, or may be delayed until a specific event takes place. Once transmitted, electronic files are stored and indexed at the remote storage location in a database. The files are typically indexed by their corresponding document identifiers. In one embodiment, the indexing and storage operation is automatic and requires little or no user sophistication or complex user-oriented software applications.

### BRIEF DESCRIPTION OF THE DRAWINGS

FIG. 1 depicts a block diagram of a form-based record management system.

FIG. 2 depicts a block diagram of a portion of the form-based record management system of FIG. 1, including a block diagram of a user workstation and associated drivers, plug-ins, and applications.

FIG. 3 depicts one embodiment of a device for use with the form-based record management system of FIG. 1.

FIG. 4 depicts one embodiment of a remote storage location for use with the form-based record management system of FIG. 1, including a protection scheme safeguarding a local access network from outside connection requests.

FIG. 5 depicts a dialog box for use by the form-based record management system of FIG. 1.

### DETAILED DESCRIPTION OF THE INVENTION

1. Overview of the Embodiment

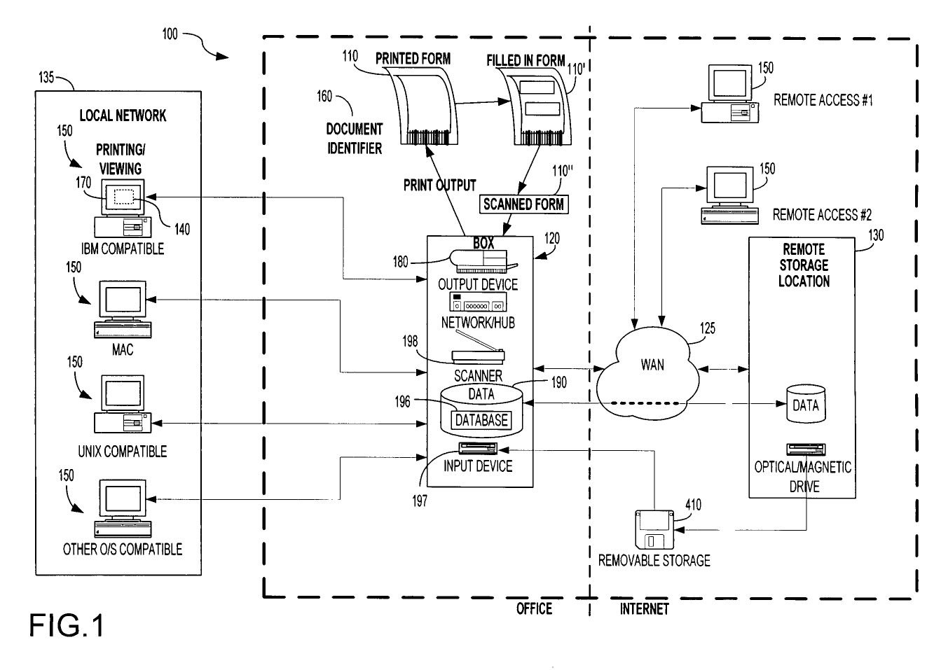

Generally, one embodiment 100 of the present invention (shown in FIG. 1) takes the form of a form-based business record management system. The embodiment 100 may create, print, scan, store, transmit, index, and retrieve form-based records 110. Typically, the embodiment electronically stores and processes form-based records 110, or “forms.” The terms “form-based records” and “forms,” as used herein, are intended to embrace any sort of document amenable to computer-based indexing and management. For example, patient and client records are examples of forms 110, as are insurance claims and waivers. Word processing documents are yet another example of forms 110, as are spreadsheets and electronic mail messages.

Operation of the embodiment typically takes place in or employs one or more computing systems. Exemplary “computing systems” include personal computers, minicomputers, microcomputers, macrocomputers, distributed systems, network servers, web tablets, wireless computing devices, personal digital assistants, and so forth. It should be understood that the terms “processing” and “processes” embrace the activities of creating, printing, scanning, storing, transmitting, indexing, and retrieving forms, as well as other activities described herein.

For example, the embodiment 100 may present a user with multiple types or configurations of forms 110 for use. These forms 110 may be stored locally at a front end of the embodiment (“box”) 120, or remotely at a remote storage location 130 connected via a network connection 145 to the box. To a user, the remote storage location 130 appears to be a local device (i.e., local with respect to the box), such as a printer or other output device. Accordingly, the network connection is transparent to a user.

Generally, at least some form types 110 are locally stored at the box 120. Alternatively, some forms 110 may be provided by a third party, and may incorporate third-party software packages. Typically, forms 110 are presented to a user as a display within a web browser 140 resident on a computer 150. The forms 110 may be extensible markup language (XML) documents, hypertext markup language (HTML) documents, portable document format (PDF) documents, joint photographic experts group (JPEG) documents, tagged image file format (TIFF) documents, ASCII documents, plain text documents, graphical objects, a combination of any of the above, or any other document format capable of being displayed on a computer system 150. In addition to display within a web browser 140, alternative embodiments may display various forms within a word processor, spreadsheet, database application, dedicated application, and so forth (collectively, “application program”). The forms 110 displayed may be blank (in which case, it is likely a new form), or completed (in which case the user has previously completed and scanned the form). Typically, the embodiment generates and assigns a unique document identifier 160 to each form or group of forms, as discussed in more detail below.

Once the user selects the appropriate form 110, he may review the form. Typically, such review takes place on a display device 170, such as a monitor, cathode ray tube, liquid crystal display (LCD), plasma display, and so on. After reviewing the form 110, the user may print the form on an attached output device 180. Exemplary output devices 180 include, for example, laser, inkjet, thermal, and dot-matrix printers. Alternatively, the user may print the form without review, thus skipping the display and review process. When printed, the form generally includes a unique document identifier 160, as discussed in more detail below. The printed form 110 may then be filled out, adjusted, revised, or otherwise completed by the user or another person.

Once the form 110 has been completed, changed, or reviewed as necessary, the user may scan the form. The scan operation converts the form 110 into an electronic file format (such as the aforementioned XML or PDF formats), which may then be stored on a computer-readable storage medium 190. Exemplary storage media 190 include optical media such as CD-ROM, CD-RAM, DVD-ROM, DVD-RAM, magnetic storage media such as hard disks and magnetic tapes, and programmable media such as flash memory, EPROMs, random access memory, and read-only memory, as well as any other storage medium capable of holding a computer-readable electronic file. Generally, the terms “electronic record,” or “electronic file,” or simply “file,” refer to an electronic file corresponding to a scanned form 110.

The embodiment 100 may store and index the electronic file either locally or remotely. For example, the electronic file may be stored and indexed in a database on a hard disk located at the user's place of business. Alternatively, the embodiment may establish a network connection 145 to a remote computer and transmit the file to a remote storage location 130. Generally, the embodiment 100 indexes electronic files prior to transmission, but alternative embodiments may index files after transmission. For example, a multitude of electronic files from one or more users may be centrally stored at a network server. Transmission of electronic files across the network to the server 130 may occur immediately after a document 100 is scanned and corresponding electronic file created, or may be delayed until a specific event takes place. For example, transmission may occur at set times (once an hour, every day at midnight, and so forth) or when a certain volume of electronic files have been created (one megabyte of files, ten files, and so on). Regardless, once transmitted, electronic files are stored and indexed by the remote storage location. Indexing is discussed further below.

2. Operation of the Embodiment

Still with respect to FIG. 1, a schematic of an embodiment 100 of a form-based business record management that may be used in an office network environment is depicted. The embodiment includes one or more devices (shown in FIG. 1 as the box 100 previously mentioned) and/or software to print, scan, index, and store form-based records 110 (“forms”) for subsequent retrieval. The form-based records may include a unique identifier or index 160, such as a barcode or other magnetically or optically-recognizable identifier, allowing the device 100 and software to automatically index the individual form-based records. The identifier 160, for example, can be printed on each page, may identify each individual form 110, or a group of forms that are collectively identified.

The box or device 100 is generally connected to a remote storage location 130, such as an Internet-Based Service. The box 120 may be connected to the remote storage location by a network 125, a direct connection or any other suitable type of connection. A network 125, for example, can include a local area network (LAN), a wide area network (WAN) (as shown in FIG. 1), an intranet, the Internet, or any other type of suitable network. A direct connection, for example, may include a modem connection, a digital subscriber line (DSL), cable modem connection, a wireless connection, a satellite connection or any other type of suitable direct connection.

The embodiment 100 also generally provides for remote access. As shown in FIG. 1, remote access may be implemented through the use of an Internet-enabled World Wide Web browser (“web browser”) 140 over a WAN 125, including, for example, the Internet. Other remote access implementations however, could be used to provide a user remote access to the device 110, the remote storage location 120, or both the device and the remote storage location. For example, file transfer protocol (FTP), transmission control protocol (TCP), user datagram protocol (UDP), and so forth may be used. Effectively, any protocol facilitating connection across any network 125 may be employed by the present embodiment.

The box 120 may be accessed by a user, such as via the local network 135 shown in FIG. 1, to print and view form-based records 110. The network 125, again, may include a local area network (LAN), a wide area network (WAN), an intranet, the Internet, a wireless network, a radio frequency network, an infrared network, a cable network, or any other type of suitable network. Alternatively, the device 120 may be directly connected to a single workstation 150, such as a personal computer.

The box 120 is generally an integration of electronic components, including components such as a printer 180, a document scanner 195, non-volatile storage mechanisms 190 such as an optical storage (e.g., a CD-ROM, a DVD-ROM, a CD-RAM, a DVD-RAM), or magnetic storage mechanism (e.g., a hard drive), a processing system (e.g., a CPU and memory), an input device 197 and/or network or direct connection components enabling connections to the user and the remote storage location 130 (e.g., a router, a modem, a DSL, a parallel connector, a serial connector, or a universal serial bus (USB) connector). As used herein, “storage device” 190 may embrace either volatile or non-volatile data storage devices, unless specifically indicated otherwise. The box 120 also may include software facilitating various functions of the embodiment 100, as well as possibly providing connections for the user locally and/or remotely and providing connections to the remote storage location 125. The software may include drivers for printing, scanning, indexing, storing, and retrieving form-based records 110. The box 120 further typically includes means (such as software) for generating a document identifier 160 facilitating indexing each page of the form-based records 110, each form-based record, or a group of individual form-based records. In addition, software may provide a connection between the user and the remote storage location 125 (such as Internet gateway services from the office LAN 135 to the WAN shown in FIG. 1).

3. Local Box Functionality

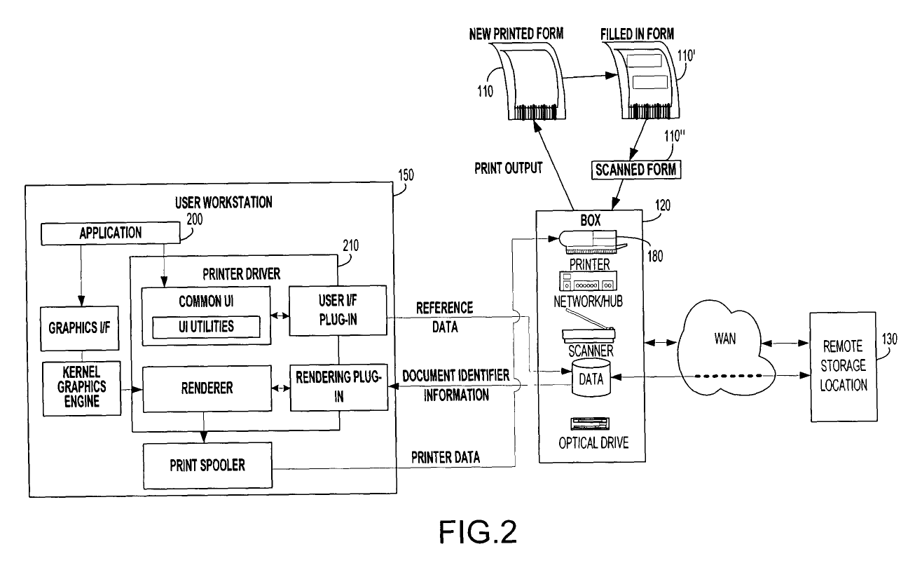

The embodiment typically provides a single device 110 (see, e.g., FIGS. 1 and 2), also referred to herein as a “box,” that performs each of the local functions transparently to the user. The box 120 also generally provides for automatic installation of device drivers (e.g., printer, network, and other drivers) to individual workstations 150, allowing users to communicate with the box 120 as a single peripheral device. In this manner, the box 120 handles and processes any communications between a user workstation 150 and a component 120, 180, 190, 195, 197 of the box.

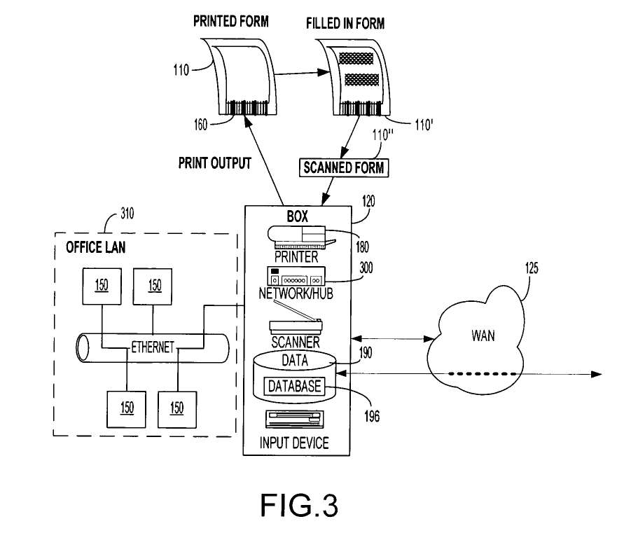

The embodiment 100 typically also provides for the introduction of automatic features of the box 120 into device driver subsystems of the user workstations 150. A connection between a workstation 150 and a local database 196 and the creation of a unique document identifier 160 for a particular form 110 or a group of forms may occur through a device driver, such as a printer 180 device driver, by a plug-in to a renderer component of the driver. The box 120 installs the plug-ins to each local computer system 150 by means of, for example, a dialog with the user through the user's Internet browser 140. This is generally shown in FIG. 3.

In one embodiment 100, the box 120 may appear to the user as a drive mapped to the user workstation 150. In this embodiment, the device 120 installs storage device plug-ins in the same manner as the printer driver plug-ins, and the resulting storage device 190 appears as a mapped drive or printer accessible by the user workstation 150. The implementation of the box 120 as a mapped drive facilitates storing and retrieving document files based on user input, such as through commonly used dialog user interfaces (shown in FIG. 2 and discussed below). Similarly, the implementation of the box as a mapped printer facilitates printing and retrieving documents files based on user input.

As shown in FIG. 3, the box 120 may include a network hub 300 or other element facilitating a network connection, thus providing network and print services to an office LAN 310, which in turn coordinates communications with individual workstations 150. The box may, for example, include a WAN gateway 300 for connection to a wide area network 125 and/or an Internet connection. The device further provides for automatically tagging documents 110 with a unique document identifier 160 as they are provided to the printing device 380 or otherwise queued in a print server. The unique identifiers 160, such as the barcodes shown in FIG. 3, are generally applied to the documents 110 in a reserved area on each printed page. The identifiers 160 are also stored in a local database 196 that resides on the box's data storage 190 and operates in the background. The local database 196 retains information about each document 110 locally produced by the box 120 and associates this information with the unique identifier 160.

The box 120 further includes a scanner component 195 to capture a changed form 110′. A software application typically examines the scanned form 110″ automatically to identify the unique document identifier 160. The scanned form 110″ is then stored for retrieval. Scanned forms 110″ that do not have an identifier 160 may be placed in an electronic folder where they may be viewed and identified by a user on the LAN 310.

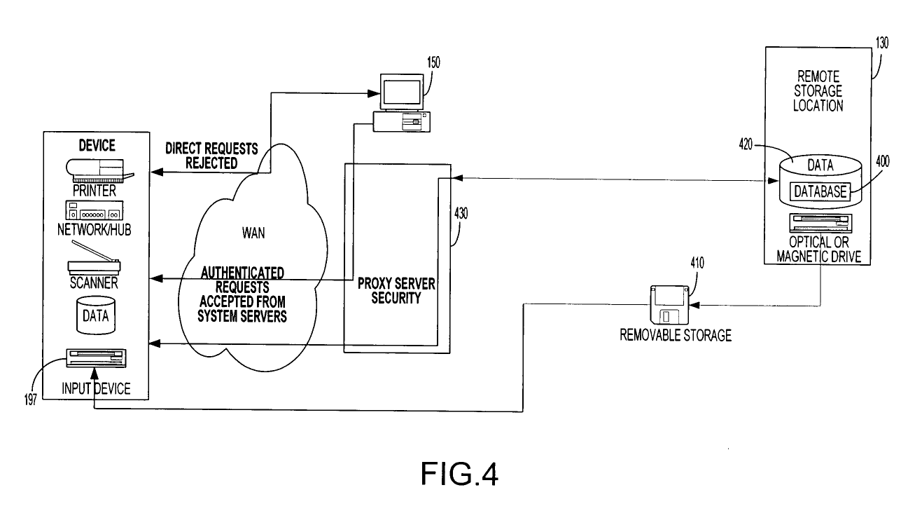

The forms 110 and corresponding database 196 files may be copied to the remote storage location 130, where a complete backup copy is typically maintained. The remote storage location 196 generally includes a remote database 400 resident on a remote data storage device 420 (shown in FIG. 4), in which forms 110 and files are stored and indexed. The remote database 400 may be, for example, a SQL database. As discussed in further detail below, the remote and local databases 400, 196 effectively mirror one another. Further, a backup data copy may be copied periodically to media 410 (e.g., optical or magnetic media or other removable storage) and shipped to a client. The media 410 containing the backup data copy can be placed in a drive 197 of the device 120 as a backup of the database 400 or may be used to provide a permanent record of the database. Such data copying and shipping may occur periodically, or may occur at a client's request. If the backup is non-volatile, it may satisfy various legal standards for record keeping in a manner similar to microfilm.

The forms 110 may be retrieved and viewed by a user via the LAN 310 or the WAN 120. The user may view lists of available documents via a web browser 140 on a workstation 150 as described above, and select individual forms 110 to view or manage through this browser interface.

4. Remote Storage Location Access and Functionality

The embodiment 100 also facilitates access to the box 120 (or “device”) by a local user or a remote user, access by the device to the remote storage location 130, and access to the remote storage location by a local user or a remote user. Returning to FIG. 1, a local user's workstation 150 may be connected to the device 120 via LAN services, such as dynamic host configuration protocol (DHCP) or security services. In this example, local workstations 150, remote workstations, and the device 120 are further connected to an Internet-based remote storage location 130 via WAN 125 services, such as an Internet gateway and/or firewall.

The remote storage location 130 may provide device managing functions, data managing functions, and/or a new platform for embodiment enhancement. The remote storage location 130 generally manages the device 120 by updating applications 200 and driver 210 software, as shown in FIG. 2. Thus, the remote storage location 130 may provide for updating applications 200 and driver software 210 for the device. The remote storage location may also maintain security, control access, and maintain a firewall to protect access to the remote storage location, as shown in FIG. 4. The remote storage location 130 may, for example, implement a security protocol, such as a proxy server 430. The proxy server 430 may reject requests for data resident on or connection to the box 120 received from a remote workstation 150 (i.e., one outside the office network attempting to connect to the box 120 via the WAN 150), or other requests that do not pass through the proxy server 430. In this manner the remote storage location 130 effectively acts as a firewall for the box 120.

The remote storage location 130 also typically manages data (such as scanned forms 110″ and files), for example by synchronizing the remote database 400 and local database 196, providing access to the data by authorized remote users (e.g., a doctor may access the database through an Internet-enabled browser from home or an authorized pharmacy may access a particular prescription form) over the Internet 125 or another connection (such as through an Internet-enabled browser 140), or by providing shared access for business partners (e.g., medical referrals from a primary care physician to a specialist). The remote storage location 130 may also provide non-volatile backup copies 410 of the data to a client. For example, the remote storage location 130 may periodically copy the database 400 onto non-volatile or volatile media 410, such as an optical media, that may be shipped to each client for disaster recovery purposes and to provide permanent data records. The media 410 may be read by the input device 197 at the box to facilitate disaster recover. The remote storage location 130 may also provide a platform for enhanced services that may be provided to a client. For example, the remote storage location 130 may provide individual services such as scheduling, accounting, and workflow management on a subscription basis to individual clients, or may allow selected vendor access to the individual clients.

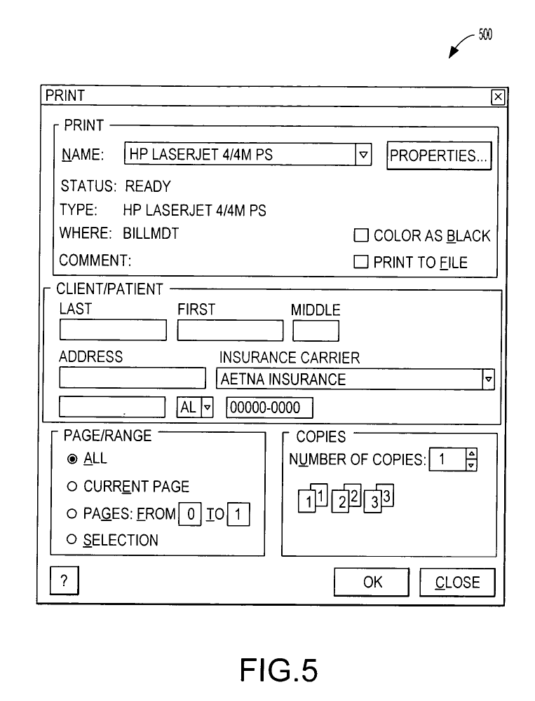

FIG. 4 depicts an exemplary implementation of the remote storage location 130. In this embodiment, the remote storage location provides a transparent backup to the box, which is typically located at a client site. A database 400 is resident at the remote storage location 130. The database 400 and filed forms 110 (which may be graphical images, optical-character recognition (OCR) converted files, XML objects, or a file of any other format discussed herein) are copied from the device 120 to a remote mirror database 400 located at the remote storage location 130. The remote storage location 130 also manages the configuration of the box 120 at each client site, possibly including maintaining current revisions of software applications and providing installation of client selected new applications. Applications may be provided by the remote storage location 130 provider, or by third parties with the permission of the client. Each box 120 typically includes a firewall set to only accept access from the remote storage location 130. Thus, requests for data resident on a box 120 must first pass through the remote storage location provider 130. FIG. 5 depicts the box's 120 firewall, applications, and drivers in greater detail.

5. Document and Client Identifiers

In the present embodiment, each document 110 is provided with a unique document identifier 160. The identifier 160 may be, for example, an alphanumeric string, or may be a uniquely generated computer-readable code. Such document identifiers 160 may contain additional document data, such as the date and time the document 110 was created, printed, scanned, or otherwise accessed, the location at which the document or corresponding electronic file 110 was created, scanned, or otherwise accessed, the date and time the document was last stored, and so on.

In the present embodiment 100, a document identifier 160 includes a location identifier. As mentioned above, each embodiment 100 includes a device 120 (or “box”) located at a user's office, place of business, or other location. Each such box 120 is assigned a unique client identifier. By incorporating the client identifier of the box 120 at which the form 110 was created into the form's document identifier 160, the point of origination of each form may be easily identified. This facilitates the tracking and management of forms 110 and associated electronic records 110″. The document identifier 160 generally also includes a unique random string differentiating each document 110 generated at a particular box 120 from other documents so generated. The document identifier 160 may also include a client or patient identification, in order to associate the form with a particular client or patient.

When a form 110 is initially created and printed by the embodiment 100, the form's document identifier 160 is automatically generated and included on the printed form. The document identifier 160 is generated by the embodiment 100 either locally (i.e., at the box 120) or remotely (i.e., at the remote storage location 130). Thus, whenever the form 110 is later printed and/or scanned, the document identifier 160 is included with the form and may be used to index and store the form as necessary.

Some embodiments may permit scanning of forms 110 not created by the embodiment. For example, sometimes a user may have several pre-existing forms or paper documents he wishes to index, store, and manage through use of the embodiment 100. In such a case, the pre-existing form 110 generally lacks a document identifier 160. Thus, when the pre-existing form is scanned, often no document identifier 160 is present.

Further, rather than creating a form 110 or choosing a blank form from a database 196 stored in the embodiment 100, the user typically indicates in some manner to the embodiment that the form is pre-existing prior to scanning the form 110. For example, the user may select a button, menu option, embedded link, and so forth prior to scanning indicating the document about to be scanned is a pre-existing form. In response, the embodiment 100 may generate a document identifier 160 for the pre-existing form 110. The embodiment 100 may further print a label or sticker with the document identifier 160, so that the user may affix the label to the form 110 prior to scanning. Alternatively, the embodiment may simply digitally add the document identifier to the form after scanning but before storage. In either case, the embodiment 100 generates and associates a particular document identifier 160 with the pre-existing form 110.

Typically, the document identifier 160 printed on or otherwise affixed to the form 110 is optically or magnetically readable. For example, the document identifier 160 might be a bar code, which is optically readable, or may instead be encoded on a magnetic stripe or block, which is magnetically readable. As yet another alternative, the document identifier 160 may take the form of a PDF stamp or marker. In alternative embodiments, the document identifier 160 may be implemented as a DataGlyph (also known as a “smartpaper”). Basic DataGlyphs are a pattern of forward and backward slashes representing ones and zeroes, typically forming a relatively small evenly textured field. (For example, the Gettysburg Address may be encoded on approximately a one-inch square area using a typical DataGylph density of 600 dots per inch.) Thus, DataGlyphs are relatively unobtrusive to the human eye, and may be incorporated into graphics, text, or other portions of a document. DataGlyphs may also incorporate various colors, error correction techniques, and data redundancy. Accordingly, any of the above optically or magnetically readable data formats may be used as a document identifier 160 format, in addition to other formats not specifically discussed herein but known to those skilled in the art.

Once a document identifier 160 is assigned to a particular form 110, the document identifier generally does not change and is not duplicated for use with any other form. In some embodiments of the present invention, however, a document identifier 160 may be assigned to a group of forms 110 instead of to a specific or single form. In yet other embodiments, the document identifier 160 may be updated every time a form 110 is changed and scanned into the embodiment 110. This may be useful, for example, when a user's record maintenance policies require tracking specific dates and/or times at which changes are made to documents or forms 110. Alternatively, a separate document field (such as a date or time field) may be updated with the date and/or time of the last change and/or form scan, rather than changing the document identifier 160 itself.

Typically, once a document identifier 160 is assigned to a form 110 (or group of forms), the document identifier is present on the form whenever the form is viewed or printed.

6. Form Management and Printing

The embodiment 100 enables the user to perform various functions. For example, the user may print a new form 110, retrieve an existing form, print an existing form, distribute an existing form, and capture an existing form. One embodiment 100 may be used in a doctor's office to manage patient forms 110. When a new patient visits the doctor's office, for example, the user may print out a new form 110. As shown in FIG. 5, the embodiment 100 may utilize a dialog box 500 to allow the user to enter certain identifying information (e.g., demographic information) for that patient, such as the patient's name, address, and insurance carrier. The identifying information, however, may vary depending upon the preferred information to use to identify the form in a database 196, 400. Alternatively, if the patient's identifying information has already been entered in a database 196, 400 (e.g., if a new form is required for an existing patient) or other retrievable location, the embodiment 100 may retrieve the information directly from the database or other location. In yet another alternative, if the scanner 195 includes optical character recognition software (OCR), the embodiment 100 may print out a blank form 110 at this stage and later retrieve the identifying information during the scanning process.

Specifically, the user may also capture an existing form 10 via the scanner 195. For example, if a new form 110 is printed containing only identifying information of a new patient, after the patient fills out the form, such as including his or her medical history, the form can be captured using the scanner 195 and stored in the database 196, 400 for that patient. If a unique identifier 160 (such as a barcode or other optically recognizable code) is on the completed form 110″ or group of forms, the user may place the form or group of forms in the scanner and press start. The embodiment 100 (generally via the box 120) will then automatically index the scanned form 110″ or group of forms. If there is no unique document identifier 160 present on the completed form 10′ or group of forms, the embodiment 100 may display the scanned form” in a browser 140-based inbox for identification and present a scan dialog box (not shown) similar to the print dialog box 500 shown in FIG. 5 in order to retrieve identifying information for the form 10 or group of forms from the user.

When the user prints a new form 110, the embodiment 100 typically establishes a new database 196 record based on the identifying information, establishes a unique identifier 160 (e.g., a unique barcode), adds the identifying information and/or the unique identifier 160 to the print image, and outputs the form 110 to the printer 180. The embodiment 100 also typically provides for auto-install of device drivers (e.g., printer drivers) to the individual workstations 150.

The user may also retrieve and/or print an existing form 110 from the databases 196, 400. The embodiment 100 may, for example, utilize a browser page to access the database 196, 400 (e.g., providing a browser database query function including auto fill), provide a candidate list of forms in the browser 140 (e.g., each form associated with a particular patient), and utilize a viewer integrated in or independent of the browser to display the form 10 to the user. The user may print an existing form 110 from the database 196, 400 via a browser print function, a viewer print function, or an embodiment function through a browser page menu.

7. Indexing

The document identifier 160 may be used to store and index forms either on the box or at the remote storage location 130. (As used herein, the terms “remote storage location” and “remote server” are synonymous.) Generally, this indexing is carried out by storing the scanned form 110″ in a database 196, 400 as an entry with at least one searchable value corresponding to the document identifier 160. In alternative embodiments, documents 110 may also be indexed or searched by client identifier, date and time created, form type, etc.

Generally, the box 120 locally sorts and indexes electronic files 110″ corresponding to the forms 110″ scanned at that particular box. As previously mentioned, the box 120 may also intermittently or continuously upload such records to a remote storage location 130. The remote storage location 130 generally similarly indexes and stores the aforementioned file 110″.

Typically, the remote storage location 130 indexes and stores a variety of forms 110 and/or corresponding files 110″ received from a number of boxes 120 or client locations. In this manner, a single remote storage location 130 may index multiple files 110″ generated by multiple users, and provide disaster recovery services for each of those users. (Disaster recovery is discussed in more detail below). By contrast, each box 120 generally stores only files 110″ corresponding to forms 110 generated at or on that box. Thus, each client may retain local storage of all files 110″ locally generated and/or changed.

Generally, the electronic files 110″ stored and indexed at the box 120 and the files stored and indexed at the remote storage location 130 are identical. As the change is made to a locally stored electronic record 110″, the changed record (or in some embodiments only those changes made to the record) is uploaded to the remote storage location 130. Typically, a changed record does not overwrite or otherwise replace a previous version of a record. Instead, the changed record is stored as a new version of the record. In this manner, a user may access previous versions of a record to track changes, review previous notes, or otherwise retrieve information that may be present on a previous version of a record, but not the most current version of a record.

Occasionally, the network connection between the box 120 and the remote server location 130 may fail due to, for example, intermittent network 125 outages or embodiment 100 hardware failure. In the present embodiment 100, if the network connection between the box 120 and remote storage location 130 is inactive when files 110″ are to be transferred from the box to the remote storage location for storage and indexing, the box may locally store such forms and/or files until the network connection is restored. At such time, the box 120 may initiate upload of the forms 110 and/or files 110″. Effectively, this permits the box 120 to synchronize forms 110 and files 110″ with the remote server location 130 even if a network connection is inoperable. Further, this provides transparency of operation to a user. That is, the user may continue to manipulate, retrieve, scan, print, and/or store scanned forms 110″ by accessing the locally-stored copy of the form on the box. Similarly, since the box 120 may upload a file whenever a network connection is available, the uploading and synchronizing operations are transparent to the user.

8. Form Storage and Purging

Typically, recently accessed or created forms 110 are locally stored on the box 120 until the box's storage device 190 approaches its storage capacity. At some point (for example, when the storage device 190 is 90% full), the box 120 may purge some or all of the forms 110 and/or files 110″ resident on the storage device. Prior to initiating such a purge, the box may verify via the network connection that accurate copies of the forms and/or files are resident on the remote storage location 130. Once the box 120 verifies a duplicate exists at the remote storage location, it may purge the local copy of the file 110″ without compromising data integrity. Further, because the network connection between the box 120 and remote storage location 130 is generally continuous in nature, a user may still retrieve or otherwise manipulate a form 110″ or corresponding file 110″ purged from the box's local storage. When the embodiment 100 receives an instruction to retrieve or otherwise manipulate such a form, it retrieves the form (or more accurately, the file corresponding to the form) from the remote storage location via the network connection. The file 110″ is then copied onto the box's local storage device 190, and the user may print or manipulate the form 110 as necessary. Generally, copies 110″ of such downloaded forms 110 remain resident on the box's local storage device 190 for a period of time. Effectively, the downloaded form is treated in the same manner as a form or file newly created locally at the box 120.

9. Remote Access

In additions to the operations and functionality already described, the embodiment 100 may facilitate distributing an existing form to a remote user. In this context, a “remote user” generally refers to a user of the embodiment who is physically located anywhere other than the location of a box 120.

A doctor's office, for example, may distribute a prescription form to a pharmacy of the patient's choice to have the prescription filled. The distribution may be performed actively, such as by e-mailing the form as an attachment or faxing the form to the desired recipient, or may be performed passively, such as by enabling selected access to one or more particular third-party users. Thus, the doctor's office may fax a prescription to a pharmacy or, upon request from the patient, the pharmacy may retrieve the prescription directly from the database.

When a user attempts to remotely retrieve a file 110 directly from a database 196, 400 (either at the remote storage location or the box), the embodiment 100 may prompt the user to provide some form of identification, such as a username, password, or both.

Typically, the embodiment 100 provides a username and/or password (hereinafter simply “username”) for each registered user. Each username is generally linked to one or more forms 110, which in turn may be retrieved when the user provides his username to the embodiment. Depending on the permissions associated with the username, a retrieved form 110 may also be printed, scanned, modified, or otherwise manipulated. Further, depending on permissions, a user may be permitted to view certain forms 110 and manipulate others when providing the username.

As previously alluded to, different usernames may provide different types of access for a remote user. For example, one username may permit access to all forms 110 of a certain type. Another username may permit access to all forms 110 generated by a certain user. Yet another username may permit access to all forms 110 associated with a certain patient, client, or other third party. Further, each of these permission types may be specific to forms created by a single user, or may span forms 110 created by multiple users.

Continuing the examples, presume three remote users each are provided different usernames, and each have different purposes for accessing the embodiment. A first user might be a pharmacist filling a prescription prepared by a doctor. Upon accessing the embodiment and providing her username, the pharmacist may be permitted access to all prescription forms created by the doctor in question, but perhaps not medical history or insurance claim forms. This is an example of access to all forms 110 of a certain type.

The second user may be an insurance auditor renewing the doctor's insurance policy. Upon accessing the embodiment, the auditor may be allowed access to all forms generated by the doctor. This is an example of third party access to all forms 110 created by a certain user.

The third user in this example may be the doctor's patient. By accessing the embodiment (either the box or the remoter server location) and providing a username, the embodiment may facilitate the patient's review of all electronic records pertaining to him and created by a specific user. Alternatively, the embodiment may facilitate review of all electronic records pertaining to the patient, regardless of creator. Both are examples of access to all forms 110 associated with a particular entity.

Any of the above types of access may be read-only, or may permit printing and re-scanning of forms 110 (effectively updating the record corresponding to such a form), as well as any type of electronic manipulation supported by the embodiment 100. Accordingly, not only may access to forms 110 be customized, but so may interaction with forms.

10. Third-Party Software

As previously mentioned, the present embodiment 100 may accept, integrate, and interact with third-party software. Such software may extend or facilitate the functionality of the embodiment. For example, some software may permit a client to bill patients (or other service or goods recipients), track embodiment usage, perform inventory, and so forth. As a further example, the individual services such as scheduling, accounting, and workflow management may be provided. With respect to any such service or software, the data created and manipulated by the third-party software may be copied, stored, and (if necessary) indexed by the remote storage location 130 as described herein. Continuing the example, a doctor's medical or drug inventory may be tracked by third-party software, and the inventory results uploaded and stored at the remote location 130 at set intervals. The client may then retrieve the inventory data from the remote storage location as desired and described elsewhere herein. Such functionality may be offered on a subscription basis to individual clients or selected vendors.

11. Subscription Models

Access to the embodiment 100 may be implemented as a subscription-based Internet 125 service. A user may, for example, pay a flat fee for access to the embodiment 100 and the functionality described herein for a given time period (for example, monthly). Alternatively, a user may pay a fee each time he accesses the remote storage location, whether to upload, download, or otherwise manipulate forms 110 or other records 110″ stored thereon. A user may similarly be charged a fee for each form 110 created, printed, or scanned, whether or not the remote storage location 130 is accessed. As yet another option, a flat fee may be charged for a certain number of operations, and incur a fee for each operation over that number. For example, a doctor may pay $10 per month to generate and store one hundred forms 110, and pay an additional ten cents per form over the hundredth.

12. Disaster Recovery

Occasionally, due to hardware failure or external factors, a box 120 may require replacement. In one embodiment, a disaster recovery service may be provided by providing (for example, by mail or package carrier) a replacement of an entire box 120 including all data and document history from the remote storage location 130. The box may be pre-configured with a client identifier identical to the device it is replacing, or a new client identifier may be assigned. Generally, the box 120 is pre-loaded with software and drivers, as previously described, to minimize user setup or interaction.

Also occasionally, forms 110 and/or files 110″ may be corrupted, damaged, or accidentally deleted from the box's storage device 190. In such a situation, the embodiment 100 may detect either locally or at the remote storage location 130 that certain files have been damaged or deleted. If the embodiment 100 detects file corruption locally (i.e., at the box), the box 120 may request, via the network connection, the remote storage location 130 download copies of the damaged or deleted forms 110 and/or records 110″. In another embodiment, where the file corruption is detected remotely (when, for example, an upload of corrupted files is attempted), the remote storage location 130 may initiate downloading of non-corrupted file copies to the box's local storage 190. In these manners, the local damaged file may be replaced without any input from (or even knowledge by) a client.

Electronic records 110″ may also be damaged or accidentally deleted at the remote storage location 130, in which case the above processes may be reversed. Effectively, the remote storage location 130 may receive via the network connection copies of the damaged or deleted files from the box 120.

Alternately, the box 120 may request, via the network connection, a copy of damaged files be made on, for example, a CD-ROM, magnetic disk, or other optical or magnetic media 410. This request may be automatically executed by the remote server 130, or may appear as a prompt, flag, or other indicator on a display device 170 (such as a printer or monitor) at the remote server to request human interaction. Regardless of how the file copy is made, it may be sent via mail or package carrier to the client. The client may then copy the files from the file copy onto the box's local storage device. Alternately, once a file copy is inserted into an appropriate input device 197 connected to the box 120, the embodiment 100 may recognize the media, file(s), and/or other data (such as a metatag or computer-readable instructions) and automatically initiate replacement of damaged files.

13. Conclusion

While the preferred embodiment has been described as part of an exemplary form-based management system, the present invention may be used to manage other form-based records as well. For example, a medical office such as a doctor, chiropractor, or dentist office may include forms for recording a patient's medical history, patient office visits, prescriptions, referral to specialists, insurance claims, orders for supplies, and invoices. The forms may also be automatically or manually forwarded or retrieved outside of the individual office (e.g., a pharmacy may retrieve a prescription for a particular patient, or a referral to a specialist may be automatically forwarded to the specialist's office). Other professional offices may equally benefit from a form-based business record management system of the present invention. Legal offices may manage document histories, invoices, and other form-based documents. Architects may manage databases of specifications, work orders, contracts, and invoices. Accountants may manage databases of various documents and forms. Pharmacies may manage databases including prescriptions from doctors and prescription forms to be given to patients. Financial offices may utilize the system for managing loan and mortgage applications, survey requests, appraisals, credit reports and requests, contact documents, note and loan documents, and the like. Further, any company that utilizes forms such as orders, shipping notices, invoices, job tickets, lot tickets, inventory controls, parts control tickets, and the like may utilize such a system.

While the invention has been described in conjunction with the specific embodiments outlined above, it is evident that many alternatives, modifications, and variations will be apparent to those skilled in the art. Accordingly, the preferred embodiments of the invention are intended to be illustrative and not limiting. Various changes may be made without departing from the spirit and the scope of the invention as defined in the following claims.

What is claimed is:

1. A method for managing form-based records comprising:
generating a unique identifier;
printing a form including the unique identifier;
scanning the form to capture information including the unique identifier;
storing the information as a record in a database; and
indexing the record by the unique identifier.

2. The method of claim 1, further comprising the operation of synchronizing the database with a remote database.

3. The method of claim 2, wherein the operation of synchronizing the database with a remote database comprises copying the information from the database to the remote database.

4. The method of claim 2, wherein the operation of synchronizing the database with a remote database comprises copying the information from the remote database to the database.

5. The method of claim 3, further comprising the operation of selecting a form from the remote database.

6. The method of claim 5, further comprising the operation of presenting the remote database as a local output device.

7. The method of claim 6, wherein the local output device is a local, non-network printer.

8. An apparatus for managing form-based records, comprising:
an input device;
a web browser operatively connected to the input device;
a database searchable by the web browser and storing at least one form-based record;
a display device operatively connected to the web browser and database, the display device operative to display the at least one form-based record;
a printer operatively connected to the web browser and input device;
a scanner operatively connected to the database; and
a remote storage location driver operative to display a remote storage location as a local output device, the remote storage location driver operatively connected to the web browser and database.

9. The apparatus of claim 8, further comprising:
an input device operatively connected to the database; and
an input recognition module operatively connected to the input device, the input recognition module operative to identify a file on a storage medium within the input device and copy the file to the database.

10. The apparatus of claim 9, further comprising:
a remote storage location operatively connected to the remote storage location driver; and
a remote database resident on the remote storage location, the remote database accepting files from the database.

11. The apparatus of claim 10, wherein the remote database accepts files from the database continuously.

12. The apparatus of claim 10, wherein the remote database accepts files from the database at predetermined times.

13. The apparatus of claim 10, wherein the database accepts files from the remote database.

14. The apparatus of claim 10, further comprising a unique document identifier generation module operatively connected to the database, the unique document identifier generation module operative to generate a unique document identifier corresponding to the at least one form-based record.

15. The apparatus of claim 14, further comprising:
a unique apparatus identifier; and wherein
the unique document identifier is at least partially based on the unique apparatus identifier; and
the at least one form-based record is indexed in the database by the unique document identifier.

16. The apparatus of claim 15, wherein the unique document identifier is a DataGlyph.
